(19) United States
(12) Patent Application Publication
(10) Pub. No.: US 2006/0197337 A1
(43) Pub. Date: Sep. 7, 2006

(54) Identification document with lenticular watermark

(75) Inventors: Trevor Merry, Ottawa (CA); David N.C. Cruikshank, Carleton Place (CA); Ileana Buzuloiu, Ottawa (CA)

Correspondence Address: CASSAN MACLEAN, 80 ABERDEEN STREET, SUITE 401, OTTAWA, ON, K1S 5R5, CA

(73) Assignee: Canadian Bank Note Company, Limited

(21) Appl. No.: 11/072,789

(22) Filed: Mar. 4, 2005

(51) Int. Cl. B42D 15/00

(52) U.S. Cl. 283/109

(57) ABSTRACT

An identification document and method of making such a document includes a transparent window which incorporates micro printing and lenticular technology to record document bearer specific information on a microscopic and macroscopic level. A window is punched into an opaque layer, respective laser engravable synthetic transparent layers are laminated to opposing sides of the opaque layer, and respective protective synthetic transparent layers are laminated to the outer sides of the two laser engravable synthetic transparent layers. A lenticular array is then formed on the front of the window in the associated protective synthetic transparent layer and then document bearer specific information is micro printed using a laser inscribing into the rear of the window in the laser engravable synthetic transparent layers. The phase shifted image is comprised of alphanumeric characters which are readable with the aid of a magnifying device, but which are also arranged to form a macroscopic lenticular image viewable through the lenticular array.

### CROSS-REFERENCE TO RELATED APPLICATIONS

Not applicable.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever

### BACKGROUND OF THE INVENTION

1. The Field of the Invention

The invention relates to the field of identification documents and more particularly to an identification document with enhanced security features.

2. The Relevant Technology

As will be appreciated by those in the art, identification documents in the form of financial transaction cards, driver's licenses, entitlement cards, travel documents (e.g., passport) and the like are widely used in our daily lives. In each case the identification document is used to verify that the document bearer has the rights and privileges associated with the document e.g., to purchase goods on credit, operate a motor vehicle, receive government services, cross borders, etc. As a result, such documents have inherent value and the issuing authority seeks to ensure that such documents cannot be easily forged or altered. As these documents are personalized in large volumes, the security features must lend themselves to high-speed production. Typical security features found in identification documents include, among other things, holograms, watermarks, micro printing, security threads, and indicia sensitive to ultra-violet or infra-red light.

With respect to microprinitng, U.S. Pat. No. 5,178,418 entitled “Latent Images Comprising Phase Shifted Micro Printing” issued on Jan. 12, 1993 to the applicant, describes a security device and method for producing the same, which provides two distinct security features, one at a microscopic level and the other at a macroscopic level. The security device comprises a substrate which has applied thereto an array of characters. The characters are of a sufficiently small size as to appear uniform when ordinarily viewed but individually identifiable when viewed with the aid of appropriate magnification means. Group(s) of the characters can be phase-shifted relative to the others in such a manner as to collectively define a latent image, the image being relatively indiscernible when the device is ordinarily viewed but discernible when viewed with the aid of a finding screen such as a separate lenticular screen. Preferably, the array of characters comprises a plurality of lines of alphanumeric characters which are generated using a computer. The character array is preferably printed using intaglio and offset printing. The microscopic and macroscopic effects obtained using the techniques described above, offer one measure of ensuring that a given identification card is authentic. However, the printing methods described are not suitable for applying variable personal data to security cards and do not take advantage of modern laser inscription technology.

U.S. Pat. No. 4,894,110 entitled “Identification with a Visible Authenticity Feature” issued Jan. 16, 1990 to Lass et al. discloses imprinting information on a multilayer identification card by means of a laser beam. The information is recorded by irreversibly changing (blackening) transparent synthetic material. By controlling the laser beam intensity, information is recorded only in one layer or simultaneously in several layers. If the layer arrangement, layer materials and recording parameters (intensity, writing width, etc.) are selected appropriately, images can be produced which change their appearance when the viewing angle is changed. The various visual effects which are obtained using this technique, serve to distinguish the authenticity of the identification card.

This patent discloses, in particular, an identification card which includes a transparent window. An opaque core layer has a window punched therein and is sandwiched between two synthetic transparent layers. The card layers are joined together by applying heat and pressure, the window in the layer being filled in by the melted synthetic transparent layers. In the window, a parallax image can be produced using the laser at different intensities as described above. The parallax image could comprise a logo or emblem, incorporating card-individual data such as an account number.

U.S. Pat. No. 4,765,656 entitled “Data Carrier Having an Optical Authenticity Feature and Methods for Producing and Testing Said Data Carrier” issued Aug. 23, 1998 to Becker et al. discloses an identification card which incorporates a lenticular screen which provides an optical feature which renders different information at different viewing angles. More specifically, using a laser beam, information is etched through the lenticular screen onto an opaque surface below at a specified angle. Information imprinted in this manner is only visible at the angle at which the laser beam hit the surface of the lenticular screen.

Although the above concepts work adequately for their intended purpose, a superior identification document can be obtained by taking advantage of the techniques disclosed to produce enhanced security features.

### SUMMARY OF THE INVENTION

In order to provide enhanced security features, an identification document and method of making such a document is disclosed. The identification document comprises a transparent window which incorporates micro printing and lenticular technology to record document bearer specific information on a microscopic and macroscopic level. Not only is the micro printed window extremely difficult to reproduce, the meaningful information contained therein can be compared with identical information repeated in another area of the card to determine the card integrity. A window is punched into an opaque layer, respective laser engravable synthetic transparent layers are laminated to opposing sides of the opaque layers, and respective protective synthetic transparent layers are laminated to the outer sides of the laser engravable synthetic transparent layers. The heating and pressing integral to the lamination process serves to fill in the void formed by the window with material from the laser engravable synthetic transparent layers. A lenticular array is then formed on the front of the window in the associated protective synthetic transparent layer and then document bearer specific information is micro printed using a laser inscribing into the rear of the window in the laser engravable synthetic transparent layers. The micro printed information is readable with the aid of a magnifying device, but is also arranged to form a phase shifted image viewable through the lenticular array. Additionally, or alternately, high resolution lines or dots can be used to convey information as phase shifted images. These options allow portraits, graphic symbols, alphanumeric data or encoded data to be incorporated into the image.

In accordance with a first aspect of the invention there is provided an identification document comprising: (a) a transparent window formed in the identification document; (b) a lenticular array formed on a front surface of the transparent window; and (c) a phase shifted image laser inscribed onto a rear surface of the transparent window, wherein the phase shifted image is discernible as a lenticular image when viewed with the aid of the lenticular array.

Preferably, the transparent window is formed in a central opaque core, the phase shifted image is formed in a specified one of at least two laser engraveable synthetic transparent layers laminated to opposing sides of the central opaque core, and the lenticular array is formed in a specified one of at least two protective synthetic transparent layers laminated to opposing sides of the at least two laser engravable synthetic transparent layers.

More preferably, the transparent window is formed in axially aligned portions of two opposing opaque layers laminated to a central laser engravable transparent core, the phase shifted image is formed in the central laser engravable transparent core, and the lenticular array is formed in a specified one of at least two protective synthetic transparent layers laminated to outer sides of the two opaque layers.

In accordance with a second aspect of the invention, there is provided a method of manufacturing an identification document comprising: (a) punching a window in a central opaque core; (b) laminating at least two laser engravable synthetic transparent layers to respective front and rear surfaces of the opaque core; (c) laminating at least two protective synthetic transparent layers to opposing sides of the at least two laser engravable synthetic transparent layers; (d) forming a lenticular array on a front surface of the window, wherein the lenticular array is formed in a specified one of the at least two protective synthetic transparent layers covering the front surface; and (e) laser inscribing a phase shifted image from a rear surface of the window, wherein the phase shifted image is discernible as a lenticular image when viewed with the aid of the lenticular array, and wherein the phase shifted image is formed in a specified one of the at least two laser engraveable synthetic transparent layers covering the rear surface.

Preferably, the step of laminating the at least two laser engravable synthetic transparent layers further comprises heating and pressing the at least two laser engravable synthetic transparent layers against the opaque core with a top and bottom plate, and wherein the window is filled with material from the at least two laser engravable synthetic transparent layers during the steps of heating and pressing.

More preferably, the step of forming further comprises providing a mold of the lenticular array in the top plate, heating and pressing the at least two protective synthetic transparent layers against the at least two laser engravable synthetic transparent layers and molding the lenticular array in the specified one of the at least two protective synthetic transparent layers.

In accordance with a third aspect of the invention, there is provided a method of manufacturing an identification document comprising: (a) punching axially aligned windows in two opaque layers; (b) laminating the two opaque layers to opposing sides of a central laser engravable transparent core wherein a portion of the central laser engravable transparent core is exposed in the axially aligned windows; (c) laminating at least two protective synthetic transparent layers to outer sides of the two opaque layers; (d) forming a lenticular array on a front surface of the axially aligned windows, wherein the lenticular array is formed in a specified one of the at least two protective synthetic tranparent layers covering said front surface; and (e) laser inscribing a phase shifted image from a rear surface of the axially aligned windows, wherein the phase shifted image is discernible as a lenticular image when viewed with the aid of the lenticular array, and wherein the phase shifted image is formed in the exposed portion of said central laser engravable transparent core.

The advantage of the invention is now readily apparent. By integrating a transparent window and lenticular array in an identification document, both microscopic and macroscopic security information can be embedded in the document and used to authenticate the document when compared with identical data also printed on the document.

### BRIEF DESCRIPTION OF THE DRAWINGS

A better understanding of the invention will be obtained by considering the detailed description below, with reference following drawings in which:

FIG. 1 is a front view of an identification card in accordance with the present invention;

FIG. 2 is a side view of the identification card of FIG. 1 taken about the line A-A;

FIG. 3 is a side view of the identification card of FIG. 2 depicting laser inscribing in accordance with the present invention;

FIG. 4 depicts a typical phase shifted image used in the present invention;

FIG. 5 depicts a typical lenticular array; and

FIG. 6 depicts a typical lenticule with a group of phase shifted alphanumeric characters displayed.

### DETAILED DESCRIPTION OF THE PREFERRED EMBODIMENTS

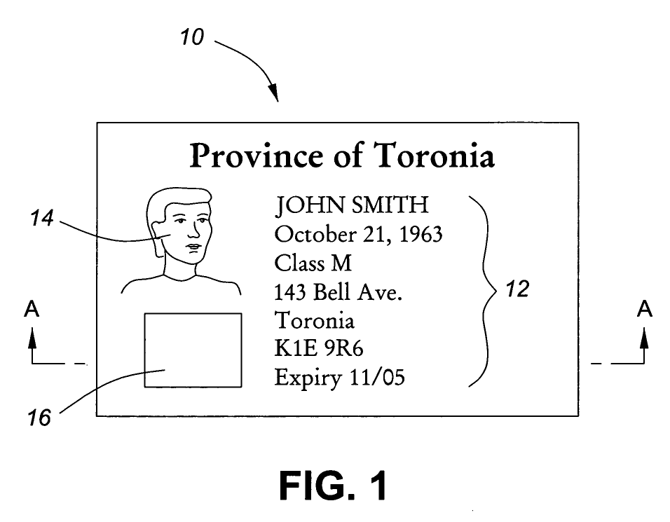

Referring to FIG. 1, there is provided an identification card 10 in accordance with the present invention. Identification card 10 could take the form of a financial transaction card, a driver's license, an entitlement card, a travel document (e.g., passport) or the like, but the invention pertains to any identification document requiring enhanced security features. Typically such cards may be used to authenticate the individual to whom the card was issued along with verifying that the card has not been forged or duplicated. As shown in the figure, identification card 10 comprises human-readable personal information relating to the card holder (shown generally at 12) which could include a name, address, birth date. In the case of a driver's license for example, the card could also include a driver class (shown as “M”) along within an expiry date (shown as “11/05”). Additionally, identification card 10 may include a photograph or portrait 14 of the card holder. The above information is applied using focused laser energy under computer control to either or both sides of identification card 10. In accordance with the invention there is also provided a transparent window 16, the construction and purpose of which will be described in more detail below.

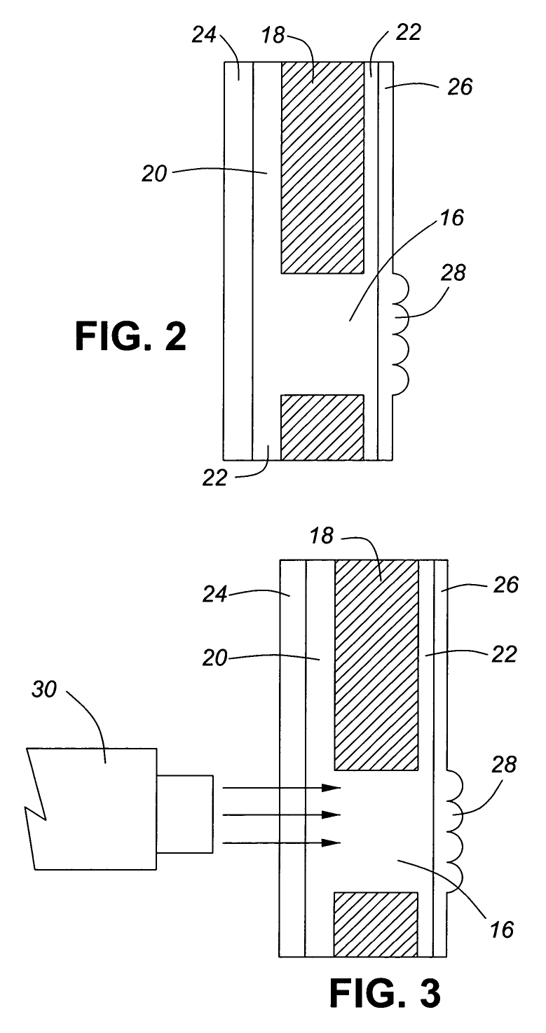

Referring to the side view in FIG. 2, identification card 10 is comprised of an opaque core 18 embedded between two synthetic transparent layers 20, 22. Opaque core 18 may comprise a synthetic film such as Bayer Corporation's Makrofol® polycarbonate film, pre-printed with authenticity marks. Window 16 is provided in the opaque layer and may be formed by a simple punch device before synthetic transparent layers 20, 22 are applied, as is well known in the art. Synthetic transparent layers 20, 22 are laminated to opposing sides of opaque core 18 by applying heat and pressure, with window 16 being filled in with adjacent synthetic transparent layers 20, 22. Synthetic transparent layers 20, 22 are preferably formed with material which accommodates laser etching, such as Bayer laser engravable Makrofol microfilm. Additional protective synthetic transparent layers 24, 26 are laminated to respective outer sides of laser engravable synthetic transparent layers 20, 22, and are formed of material which does not accommodate laser etching. A lenticular array 28 is formed in protective synthetic transparent layer 26 to cover window 16. As will be discussed below, the unique shape of lenticular array 28 allows a lenticular image to be viewed.

As shown in FIG. 3, once lenticular array 28 is formed in protective synthetic transparent layer 26, the rear of window 16 is then laser inscribed with micro printing by a computer controlled laser 30. Laser engravable synthetic transparent layers 20, 22 absorb the light from laser 30 to such an extent that blackening occurs in these transparent layers under the effect of the laser beam. The micro printing collectively forms a microscopic image capable of conveying meaningful information when viewed with the aid of appropriate magnification means. More specifically, the micro printing is preferably in the form of alphanumeric characters which define the human-readable personal information 12 printed on opaque layer 18. When scanned by an automatic reader (not shown) the micro printing can be quickly compared with the human-readable personal information 12 to ensure that identification card 10 has not been altered.

As highlighted above, identification card 10 includes lenticular array 28 applied to protective synthetic transparent layer 26. A phase shifted image 32 formed from micro printed alphanumeric characters is inscribed into the rear of window 16 in such a manner that, when it is viewed through lenticular array 28, forms a unique macroscopic image (i.e., a lenticular image) useful in authenticating identification card 10. Preferably the macroscopic image is personal data which mirrors personal data elsewhere on identification card 10. Additionally or alternately, instead of using micro printing, high resolution lines or dots can be laser inscribed into rear window 16 to convey information as phase shifted images. These options allow portraits, graphic symbols, alphanumeric data or encoded data to be incorporated into the phase shifted image. If the phase shifted image comprises a portrait, then the portrait can be compared with portrait 14 laser inscribed on opaque layer 18 and laser engravable synthetic transparent layer 22. CA 1,172,282 issued Aug. 7, 1984 to the applicant, discloses a method of producing superimposed lenticular images for producing portraits or graphic symbols as discussed above. In one embodiment described in the patent, line deflection patterns are produced from different subjects and are then superimposed onto one another. More specifically, images having substantially the same angle of orientation are offset from one another at an appropriate preferred distance.

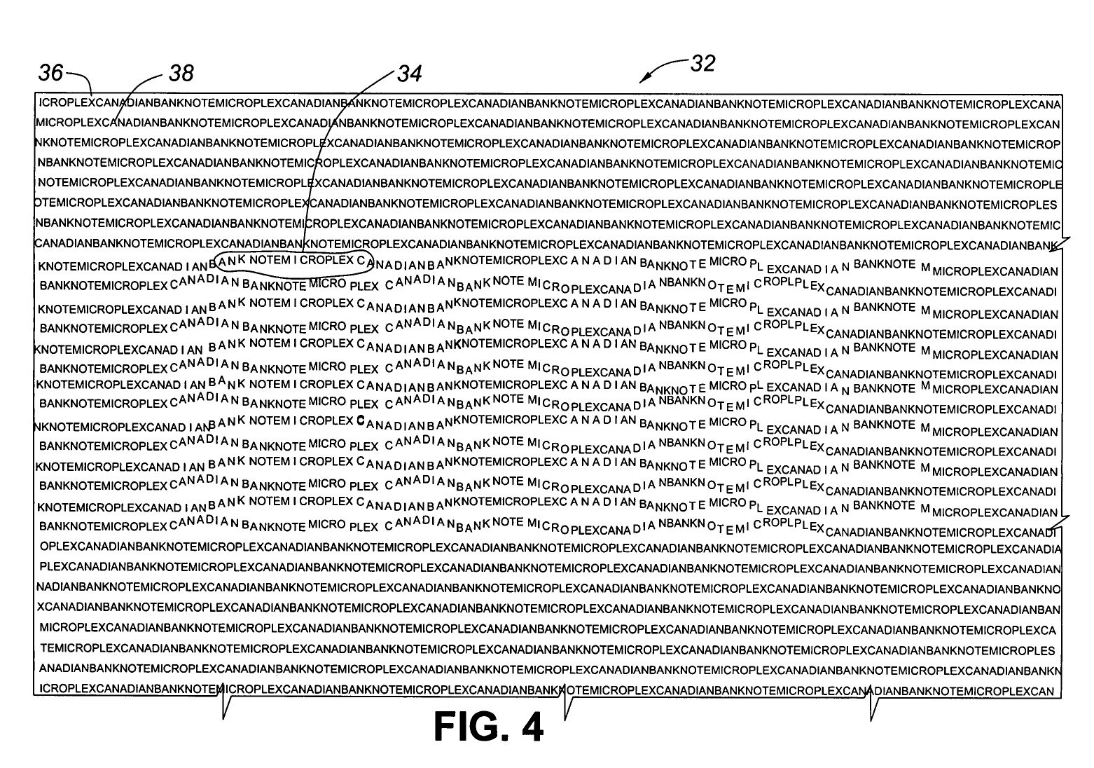

FIG. 4 depicts a typical phase shifted image 32 used in the present invention. The alphanumeric characters are of a sufficiently small size as to appear uniform when ordinarily viewed, but individually identifiable when viewed with the aid of appropriate magnification means. Groups of the alphanumeric characters, such as group 34, are phase shifted relative to the others in such a manner as to collectively define a macroscopic or lenticular image. In the preferred embodiment, a first phase shifted image (i.e., formed by odd numbered lines 36 and onward in FIG. 4) is interlaced with a second phase shifted image (i.e., formed by even numbered lines 38 and onward in FIG. 4) such that two macroscopic images are defined. When viewed from one angle through lenticular array 28, a seamless version of the first phase shifted image is visible, but when viewed from another angle through lenticular array 28, the second phase shifted image is visible. U.S. Pat. No. 5,178,418 describes various alternate micro printing arrangements used to form phase shifted images, all of which are incorporated herein by reference.

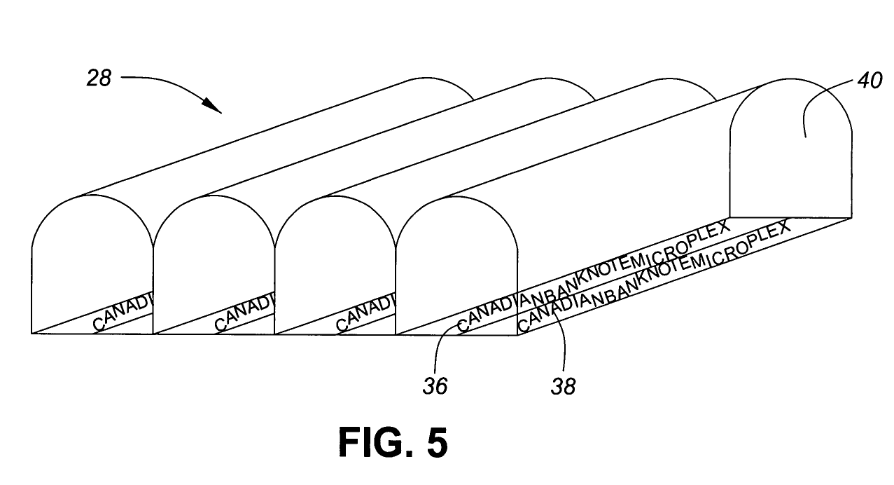

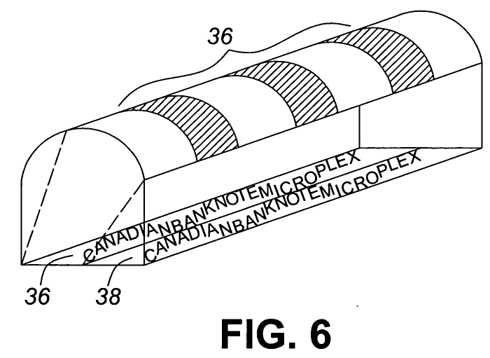

As depicted in FIG. 5, lenticular array 28 comprises a set of parallel, convex, plano-cylindrical lenses (lenticules) 40 that magnify portions of phase shifted image 32 More specifically, phase shifted groups of alphanumeric characters associated with either the first or second phase shifted images are magnified by lenticules 40 depending on the angle of view. A specified lenticule 40 magnifies an associated odd line 36 or even line 38. More specifically, the phase shifted groups of alphanumeric characters in either an odd line 36 or even line 38 are expanded across the width of the lens in such a way that, from the proper viewing distance and angle, the phase shifted groups of alphanumeric characters appear to fill the entire lens surface. As shown in FIG. 6, the phase shifted alphanumeric characters associated with an odd line 36 come into view at the optimum viewing distance and angle. As the angle is increased, phase shifted groups of alphanumeric characters associated with an odd line 36 diminish and phase shifted groups of alphanumeric characters associated with an even line 38 become apparent.

As those skilled in the art will appreciate, there are several techniques which can be used to form lenticular array 28. Firstly, a grooved roller can be used to form the array in a portion of protective synthetic transparent surface 26 sufficient to cover window 16 where phase shifted image is laser inscribed. The roller serves to shape the pliable protective synthetic transparent layer 26 into the parallel, convex, plano-cylindrical lenses described above. Secondly, a tool having a shape substantially similar to the convex shape of lenticule 40 is repeatedly dragged across the surface of protective synthetic transparent surface 26 to etch a series of parallel lenticules 40 of desired length opposite window 16. Most preferably, lenticular array 28 is formed using top and bottom plates, whereby the top plate is machined with a mold of lenticular array 28. Identification card 10 is placed between the plates where heat and pressure are applied thereto. The shape of lenticular array 28 is formed in protective synthetic transparent layer 26 by the machined mold. Using this technique, several identification cards 10 can be produced at a time.

As discussed above, either micro printing or high resolution lines or dots are laser inscribed in window 16 to form the lenticular image. Critical to any such laser inscription is the proper alignment of phase shifted image 32 with lenticular array 28. As will appreciated by those skilled in the art, if accurate alignment is not provided the macroscopic or lenticular image will appear skewed or distorted when viewed through lenticular array 28. Alignment of phase shifted image 32 with lenticular array 28 may be accomplished by: (i) using a digital representation of lenticular array 28 to calculate the angle and offset of window 16 in identification card 10 from a reference position; and (ii) aligning unwritten phase shifted image 32 by: (1) translating and rotating unwritten phase shifted image 32 so that it matches the actual, measured position of lenticular array 28; (2) rotating and translating laser 30 such that unwritten phase shifted image 32 is inscribed in window 16 of identification card 10 in the correct position relative to lenticular array 28; or (3) rotating and translating identification card 10 so that lenticular array 28 is accurately aligned with unwritten phase shifted image 32.

As will be appreciated by those in the art, the micro printing can also be used to encode biometric data in window 16 instead of or in addition to human-readable personal information 12. The biometric data (e.g., fingerprint) can be downloaded with an appropriate reader and compared to biometric data obtained from the document bearer at the time of authentication. As will also be appreciated, identification card 10 can include a contact or contactless chips, magnetic or optical stripes, or barcode each of which can be encoded with personal or biometric information and used as a further level of verification against the micro printed and human-readable information contained in identification card 10.

Although various exemplary embodiments of the invention have been disclosed, it should be apparent to those skilled in the art that various changes and modifications can be made which will achieve some of the advantages of the invention without departing from the true scope of the invention. For example, the preferred identification card has been described as comprising central opaque core 18 with window 16 formed therein and synthetic transparent layers 20, 22, 24 and 26 laminated on opposing sides of central opaque core 18. Alternately, the central core may be transparent and laser engravable, with opaque layers having axially aligned windows, laminated to opposing sides of the central core. Optionally, protective transparent layers could be applied to the outer sides of the opaque layers. In this embodiment, the lenticular array would be formed in the outer protective layer on a front surface of the window while the laser micro-printing would be formed by inscribing onto the rear surface of the window in the laser engravable transparent core.

A person understanding this invention may now conceive of alternative structures and embodiments or variations of the above all of which are intended to fall within the scope of the invention as defined in the claims that follow.

What is claimed is:

1. An identification document comprising:
(a) a transparent window formed in said identification document;
(b) a lenticular array formed on a front surface of said transparent window; and
(c) a phase shifted image laser inscribed onto a rear surface of said transparent window,
wherein said phase shifted image is discernible as a lenticular image when viewed with the aid of said lenticular array.

2. The identification document of claim 1 wherein said phase shifted image comprises micro printing and wherein said micro printing is of a sufficiently small size to appear uniform when ordinarily viewed by collectively forming a microscopic image capable of conveying meaningful information when viewed with the aid of an appropriate magnification means.

3. The identification document of claim 1 wherein said phase shifted image comprises a plurality of high resolution lines or dots, and wherein said high resolution lines forms one of a portrait, graphic symbol, alphanumeric data or encoded data.

4. The identification document of claim 2 wherein the identification document is taken from the group comprising a financial transaction card, a driver's license, an entitlement card and a travel document.

5. The identification document of claim 2 wherein said meaningful information conveyed in said micro printing comprises an array of alphanumeric characters.

6. The identification document of claim 5 wherein said array of alphanumeric characters comprise personal data, and wherein said personal data is repeated on said opaque core in human-readable form for comparison with said alpha numeric characters.

7. The identification document of claim 6 wherein said lenticular image comprises personal data and wherein said personal data is repeated on said opaque core in human-readable form for comparison with said lenticular image.

8. The identification document of claim 3 wherein said lenticular image comprises a first portrait of a cardholder, and wherein a second portrait, substantially similar to said first portrait, is affixed to said opaque core, for comparison with said first portrait.

9. The identification document of claim 1 wherein said transparent window is formed in a central opaque core.

10. The identification document of claim 9 wherein said phase shifted image is formed in a specified one of at least two laser engraveable synthetic transparent layers laminated to opposing sides of said central opaque core.

11. The identification document of claim 10 wherein said lenticular array is formed in a specified one of at least two protective synthetic transparent layers laminated to outer sides of said at least two laser engravable synthetic transparent layers.

12. The identification document of claim 1 wherein said transparent window is formed in axially aligned portions of two opposing opaque layers laminated to a central laser engravable transparent core.

13. The identification document of claim 12 wherein said phase shifted image is formed in said central laser engravable transparent core.

14. The identification document of claim 13 wherein said lenticular array is formed in a specified one of at least two protective synthetic transparent layers laminated to outer sides of said two opaque layers.

15. A method of manufacturing an identification document comprising:
(a) punching a window in a central opaque core;
(b) laminating at least two laser engravable synthetic transparent layers to respective front and rear surfaces of said opaque core;
(c) laminating at least two protective synthetic transparent layers to outer sides of said at least two laser engravable synthetic transparent layers;
(d) forming a lenticular array on a front surface of said window, wherein said lenticular array is formed in a specified one of said at least two protective synthetic transparent layers covering said front surface; and
(e) laser inscribing a phase shifted image from a rear surface of said window, wherein said phase shifted image is discernible as a lenticular image when viewed with the aid of said lenticular array, and wherein said phase shifted image is formed in a specified one of said at least two laser engravable synthetic transparent layers covering said rear surface.

16. The method of claim 15 wherein laser inscribing said phase shifted image comprises micro printing, and wherein said micro printing is of a sufficiently small size to appear uniform when ordinarily viewed by collectively forming a microscopic image capable of conveying meaningful information when viewed with the aid of appropriate magnification means.

17. The method of claim 16 wherein said micro printing comprises groups of phase shifted alphanumeric characters which, when viewed at a specified angle through said lenticular array, collectively define a macroscopic or lenticular image.

18. The method of claim 15 wherein said lenticular image comprises a plurality of high resolution lines or dots, and wherein said high resolution lines or dots form one of a portrait, graphic symbol, alphanumeric data or encoded data.

19. The method of claim 15 wherein the identification document is a taken from the group comprising a financial transaction card, a driver's license, an entitlement card and a travel document.

20. The method of claim 16 wherein said meaningful information conveyed in said micro printing comprises an array of alphanumeric characters.

21. The method of claim 20 further comprising printing personal data on said opaque core in human-readable form, and wherein said personal data is identical to said meaningful information conveyed in said micro printing.

22. The method of claim 18 wherein said phase shifted image comprises a first portrait of a document bearer, and wherein a second portrait, substantially similar to said first portrait, is affixed to said opaque core, for comparison with said first portrait.

23. The method of claim 15 wherein said step of laminating said at least two laser engravable synthetic transparent layers further comprises heating and pressing said at least two laser engravable synthetic transparent layers against said opaque core with a top and bottom plate, and wherein said window is filled with material from said at least two laser engravable synthetic transparent layers during said steps of heating and pressing.

24. The method of claim 23 wherein said step of forming further comprises providing a mold of said lenticular array in said top plate, heating and pressing said at least two protective synthetic transparent layers against said at least two laser engravable synthetic transparent layers and molding said lenticular array in said specified one of said least two protective synthetic transparent layers.

25. The method of claim 15 further comprising, prior to said step of laser inscribing, aligning said phase shifted image with said lenticular array.

26. The method of claim 25 wherein said step of aligning comprises (a) capturing a digital representation of said lenticular array; and (b) aligning an unwritten phase shifted image with said digital representation.

27. A method of manufacturing an identification document comprising:
(a) punching axially aligned windows in two opaque layers;
(b) laminating said two opaque layers to opposing sides of a central laser engravable transparent core wherein a portion of said central laser engravable transparent core is exposed in said axially aligned windows;
(c) laminating at least two protective synthetic transparent layers to outer sides of said two opaque layers;
(d) forming a lenticular array on a front surface of said axially aligned windows, wherein said lenticular array is formed in a specified one of said at least two protective synthetic transparent layers covering said front surface; and
(e) laser inscribing a phase shifted image from a rear surface of said axially aligned windows, wherein said phase shifted image is discernible as a lenticular image when viewed with the aid of said lenticular array, and wherein said phase shifted image is formed in said exposed portion of said central laser engravable transparent core.

28. The method of claim 27 wherein said laser inscribing comprises micro printing and wherein said micro printing is of a sufficiently small size to appear uniform when ordinarily viewed by collectively forming a microscopic image capable of conveying meaningful information when viewed with the aid of appropriate magnification means.

29. The method of claim 28 further comprising printing personal data on a specified one of said opaque layers in human-readable form, and wherein said personal data is identical to said meaningful information conveyed in said micro printing.
